(19) United States
(12) Patent Application Publication
(10) Pub. No.: US 2023/0089007 A1
(43) Pub. Date: Mar. 23, 2023

(54) ZINC PIGMENT

(71) Applicant: Sun Chemical Corporation, Parsippany, NJ (US)

(72) Inventors: Jonathan DOLL, Cincinati, OH (US); Lisa CLAPP, Cincinnati, OH (US); Ingo GIESINGER, Hoerbranz (AT); Dieter GROSSSCHARTNER, Pöchlarn (AT)

(21) Appl. No.: 17/969,064

(22) Filed: Oct. 19, 2022

Related U.S. Application Data
(63) Continuation of application No. PCT/US21/28752, filed on Apr. 23, 2021.
(60) Provisional application No. 63/014,805, filed on Apr. 24, 2020.

(51) Int. Cl. C09C 1/62; C09C 3/06; C09D 17/00; C09D 11/033; C09D 11/037

(52) U.S. Cl. CPC C09C 1/62; C09C 3/06; C09D 17/006; C09D 17/001; C09D 11/033; C09D 11/037; C01P 2004/80; C01P 2004/61; C01P 2006/12

(57) ABSTRACT

An oxidized zinc pigment has been developed that can be used in a waterborne coating. The zinc metal allows for improved stability in waterborne systems while retaining the level of activity required for an anticorrosive material. This pigment is oxidized enough to prevent corrosion and still be dispersed in the waterborne coating, while still allowing for cathodic and anodic corrosion protection in the coating once applied to a metal surface. This zinc pigment may also be used in a waterborne ink or coating system and also for coated metal articles.

### RELATED APPLICATION

This application claims priority to provisional application 63/014,805, titled, “Zinc Pigment” filed Apr. 24, 2020, the entire contents of which is hereby incorporated by reference.

### BACKGROUND

Corrosion is a natural and inevitable process occurring when certain materials are subjected to chemical attack from the environment. It causes widespread damage to infrastructure, automobiles, and other products, resulting in approximately $2.5 trillion in damage per year. To mitigate the damage, corrosion inhibition coatings are used to protect surfaces and items that are prone to corrosion.

Corrosion is an electrochemical process where metals are converted into their more stable native oxides or hydroxides. For ferrous metals, corrosion manifests as rust, a non-passivating, flaky red oxide that reduces structural integrity. Metals have both cathodic (electron accepting) and anodic (electron donating) sites on their surface. The presence of an electrolyte completes the circuit, allowing corrosion to occur. Anodic sites become oxidized while cathodic sites do not corrode, but rather accelerate corrosion at the anodic sites. To prevent corrosion, the circuit must be broken. Two strategies used to protect steel from corrosion involve 1) using a physical barrier to prevent the flow of electrons (anodic protection); or 2) shifting the balance of the electrochemical cell by using a more reactive sacrificial metal, making steel the cathode (cathodic protection).

One strategy used to protect steel are zinc-rich coatings which provide both anodic and cathodic protection. The zinc flakes in the coating are in electrical contact with the steel, creating an electrochemical cell with zinc, while the steel acts as the anode and the cathode, respectively. During the cathodic phase of corrosion protection, the zinc sacrificially corrodes in lieu of the steel. Once the cathodic phase is complete, the anodic phase begins, with Zn(OH)₂ providing a barrier layer on the substrate. If the barrier becomes damaged, the cathodic phase restarts and the coating self-heals.

Most zinc-rich coatings are solvent-borne (SB) systems containing volatile organic compounds (VOCs) or hexavalent chromium (Cr(VI)) which are harmful to the environment and worker health. Zinc is susceptible to corrosion in WB (waterborne) systems, producing H2 gas that can lead to container failures, and result in less effective anti-corrosion performance in the coating, among other problems. While zinc can be protected with hydrophobic and/or silica surface treatments, this strategy significantly reduces the activity of zinc pigments during the cathodic phase of protection. In lieu of good strategies to protect zinc while maintaining the activity, many formulators have opted to add unpassivated zinc to 2K or 3K WB systems, where it is added just prior to application or formulated into the crosslinker. The shelf-life of these systems is short, and ranges from hours to days. The term 2K, 3K, etc. refers to ink or coating systems that require the blending of 2 or more distinct parts (e.g. main component+hardener or catalyst) to form an application-ready finished ink or coating.

In one report, researchers used 1-nitropropane to passivate the zinc surface with a transient corrosion inhibitor. Although, the corrosion inhibitor protected the surface of the Zn in water, it left the surface on curing of the coating. However, nitropropane is a toxic additive, and is not easily used in these systems.

In another report, researchers coated zinc dust with a polymer that changed its shape after drying. While this product was successful in stabilizing the zinc in WB systems, the added processing steps required to make the coatings made this an infeasible solution.

Citation or identification of any document in this application is not an admission that such represents prior art to this technology.

### SUMMARY

This application describes a zinc pigment suitable for use in a waterborne system, represented by equation 2:

1=ϕ_{M}+ϕ_{O}+ϕ_{L} (2)

where ϕ_{M}, ϕ_{O}, and ϕ_{L} are molar fractions of unoxidized zinc, an oxidized surface layer of zinc, and a lubricant, respectively. The unoxidized zinc, ϕm, may be in a range of 0.70≤(ϕ_{M}≤0.90, and also ϕ_{M}, may be in a range of 0.74≤ϕ_{M}≤0.86. The oxidized surface layer of zinc, ϕ_{O}, may be in a range of 0.10≤ϕ_{O}≤0.30, and also in a range from about 0.14 to 0.26. The lubricant, ϕ_{L}, may be in a range of 0.00≤ϕ_{L}≤0.50, and also in a range of 0.00≤ϕ_{L}≤0.05. The lubricant, ϕ_{L}, may be selected from the group consisting of saturated and unsaturated fatty acids and mixtures thereof. The zinc pigment may have a particle size D50 in a range of 1 μm≤d50≤25 μm, and also may have a D50 in a range of 8.0 μm≤d50≤16 μm. This zinc pigment has improved stability in waterborne systems.

Further, the oxidized surface layer of this zinc pigment is a water insoluble oxide, or, a water insoluble hydroxide, wherein the oxide has the chemical formula (1) ZnₐX_{b} (1), wherein X represents either O or OH, and a and b are stoichiometric indicators of the amount of Zn or component X, and depends on the oxidation state of X. The zinc pigment may have a surface area in the range of 0.5 m²/g-20 m²/g, and may also have a surface area is in the range of 1 m²/g-5 m²/g.

Commercial uses of the zinc pigment include but are not limited to a waterborne ink or coating system and coated metal articles.

### DETAILED DESCRIPTION

This technology is further described by the following numbered paragraphs.

To overcome the issues in the prior art, an oxidized zinc pigment has been developed that can be used in a waterborne coating. A waterborne coating may be defined as a coating that contains water as one of its main components. This pigment is oxidized enough to prevent corrosion while dispersed in the waterborne coating, and still allowing for cathodic and anodic corrosion protection in the coating once applied to a metal surface.

This zinc metal allows for improved stability in waterborne systems while retaining the level of activity required for an anticorrosive material. The zinc may be in the form of a pigment with dark color comprising zinc, zinc oxide and fatty acid.

This current technology relates to an oxidized zinc pigment and its use in a waterborne (WB) coating. The oxide layer is designed such that the metallic pigments are protected from oxidation and gassing while dispersed in a liquid WB coating system, while it is thin enough to allow for cathodic and eventually anodic protection when the coating has been applied to a metal substrate. The oxide layer is oxidized either partially or completely as defined by the mole ration in Formula (2).

These zinc pigments may be amorphous with highly irregular shape. The irregular shape results in a dark color compared to smooth flakes that are brighter and more metallic in nature. These zinc pigments are comprised of zinc metal, surface oxidation, and fatty acid. The resulting composition results in a product that has improved stability in a WB anticorrosion coating.

These zinc pigments may be produced by ball milling, media milling, or other techniques known in the art without limiting the scope of the technology. Similarly, the oxidation of the pigment may be accomplished in a number of ways, such as by exposing the metal to controlled atmospheric conditions, without limiting the scope of the technology.

These zinc pigments may be any shape known to those skilled in the art, including for example spherical, platelet shapes, acicular or amorphous shaped. Additionally, the zinc pigment may be a mixture of shapes. These zinc pigments may also have a particle size and particle size distribution that varies depending on the application. The particle size distribution is measured via laser scattering methods, and this particular range is defined by the use of a Malvern Mastersizer 2000. Other instruments that can measure the particle size include Cilas and other laser scattering instruments. The median of the particle size distribution (d50) may be any value in the range of 1 μm≤d50≤25 μm, and may also be in the range of 8.0 μm≤d50≤16 μm. Additionally, the particle size distribution is further described by small particle fraction, d10 (10% of the particles have a value below this number) in the range of 0.5 μm<d10<11 μm, and may also be in the range of 1.5 μm<d10<5 μm. Additionally, the particle size distribution is further described by a large particle fraction, d90 (10% of the particles have a value above this number) in the range of 20 μm<d90<100 μm, and may also be in the range of 24 μm<D10<50 μm.

In a certain embodiment, these zinc pigments have a surface that is oxidized. The surface oxidation may be present as an insoluble oxide or a hydroxide. The oxide would have a chemical formula (1) represented by:

ZnₐX_{b} (1)

Wherein X represents either O²⁻, ⁻OH, or a mixture of both. The value of a and b are stoichiometric indicators of the amount of Zn or component x, and depends on the oxidation state of component X. The oxide of equation 1 may be neutral.

These zinc pigments may also comprise a lubricant. Lubricants may be used as processing aids during the manufacture of the pigment. Typical lubricants used during the processing of the metallic pigment include all types of saturated and unsaturated fatty acids and mixtures thereof, including stearic acid, oleic acid, linoleic acid, ricinoleic acid, palmitic acid, arachidic acid, myristic acid, lauric acid, capric acid, elaidic acid, erucic acid, linolenic acid, myristoleic acid, palmitoleic acid, and other fatty acids. The fatty acids used, and the lubricant may be saturated or unsaturated and generally contain between 1-30 carbon atoms.

In one embodiment, the fatty acid may comprise a metal soap. Metal soaps are salts comprised of a metal cation and an anionic fatty acid. The fatty acid in the metal soap may be any type of saturated or unsaturated fatty acid with 1-30 carbon atoms. The metal in the metal soap may be the same as the metal in the metallic pigment or it may be a different metal. Examples of metal soaps that can be used include, but are not limited to, zinc stearate, zinc oleate, and/or mixtures thereof.

In one embodiment, the zinc pigment is comprised of metallic zinc, an oxidized surface layer and a lubricant. The composition of the final pigment is represented by the equation (2):

1=ϕ_{M}+ϕ_{O}+ϕ_{L} (2)

where ϕ_{M}, ϕ_{O}, and ϕ_{L}, are the mol fraction of the unoxidized zinc, the oxidized surface layer of zinc, and the lubricant, respectively. The mole fraction of the unoxidized zinc, ϕ_{M}, may be in the range of 0.70≤ϕ_{M}≤0.90, and may also be in the range of 0.74≤(km≤0.86. The mole fraction of the oxidized surface layer of zinc, ϕ_{O}, may be in the range of 0.10≤ϕ_{O}≤0.30, and may also be in the range of 0.14≤ϕ_{O}≤0.26. The mole fraction of the lubricant, ϕ_{L}, may be in the range of 0.00≤ϕ_{L}≤0.50, and may also be in the range of 0.00≤ϕ_{L}≤0.05.

These zinc pigments may be characterized by their surface area. The surface area has a preferred range of between 0.5 m²/g-20 m²/g, and may also between 1 m²/g and 5 m²/g. The surface area range is determined by BET surface area using nitrogen.

The stability of the zinc is defined by a gassing test. Gassing tests are performed by immersing the metal in a solution that can cause the generation of hydrogen gas from the zinc pigment. The generated hydrogen gas is measured volumetrically. The gassing tests can include a model waterborne coating composition that is similar to the pH and solvent composition. Alternatively, the stability can be relatively assessed in water-based systems. In one embodiment, the gas generation is determined by dispersing the zinc pigment in a 50:50 solution of water and butyl glycol and stirring at 40° C. for 30 days. In another embodiment the gas generation is determined by stirring the zinc-containing coating for 50° C. for 65 hours. For these test methods the volume of generated H2 gas is determined via water displacement. In another embodiment, the zinc pigment is dispersed in a waterborne coating or water-containing mixture of solvents without stirring at 20° C. for 48 hours. This test represents an expansion of the coating or water-containing solvent mixture due to H2 gas.

These metallic zinc pigments are further characterized by the color. The color is measured using an)(Rite MA98 Multiangle spectrophotometer using the 45-as-15 measurement geometry. Under this configuration, the zinc pigment has a preferred brightness (L*) of L*15<50.

The zinc pigment may be used in any type of water- or solvent-based liquid coating. In another embodiment, the coating containing the zinc pigment may have a combination of both water and a solvent that is not water. Additionally, the coating may be a dry coating such as a powder coating or a freeze-dried coating that can be reconstituted into a liquid coating by adding water or an organic solvent. In one embodiment, the binder used in the coating may be organic. In one embodiment, the binder used in the coating may be inorganic or ceramic based. In one embodiment, the binder used in the coating may be a hybrid, containing both organic and inorganic/ceramic components. In general, the metallic pigment may be used in all types of coatings without limiting the scope of the technology.

The water or solvent based liquid coating containing the zinc pigment may be characterized by its pigment volume concentration (PVC). The pigment volume concentration (PVC) is defined as the volume fraction of pigment particles with respect to the volume fraction of the total solids in a coating. The loading of the metallic pigment in the coating is such that its PVC is at or below the critical pigment volume concentration (CPVC). The CPVC is defined as the pigment volume concentration where there is just sufficient binder present in a coating to cover each pigment particle with a thin layer and the voids between particles are filled. It is defined by the following equation (3), where pp is the specific gravity of the pigment, pp is the specific gravity of the oil or solvent, and OA is the oil or solvent absorption in grams oil or solvent to 100 g pigment.

$$CPVC = \frac{1}{1 + OA \frac{{ρ}_{p}}{100 * {ρ}_{o}}} \qquad ( 3 )$$

The oil absorption is typically determined by measuring the amount of liquid that 1 g of the metallic pigment can absorb before it wets, forming a stiff but spreadable paste that is shiny on the top. It is typically reported in grams oil or solvent/100 g pigment. For this measurement, the oil can be any type of solvent typically used in solvent or waterborne coatings, including linseed oil, castor oil, glycols, glycol ethers, etc. without limiting the scope of the technology. In one embodiment, the metallic pigment has an oil absorption (OA) when using dipropylene glycol as the solvent, in the range of 5 g/100 g pigment≤OA≤25 g/100 g pigment.

This oxidized zinc pigment may be used in a waterborne ink or coating system since it provides improved stability and brightness (L*) in waterborne systems while retaining the level of activity required for an anticorrosive material. This oxidized zinc pigment may also be used in coated metal articles containing the metallic pigment and may be applied to all types of metal parts including, but not limited to metal panels, screws, fasteners, brakes, automatic chassis components, without limiting the scope of the technology.

The present technology has been described in detail, including the preferred embodiments thereof. However, it will be appreciated that those skilled in the art, upon consideration of the present disclosure, may make modifications and/or improvements that fall within the scope and spirit of the zinc technology as described herein.

### EXAMPLES

The technology is further described by the following non-limiting examples which further illustrate the zinc technology, and are not intended, nor should they be interpreted to, limit the scope.

### Example 1

An amorphous zinc pigment made by ball milling with a median particle size, d50, of 11.7 μm as measured by a Malvern Mastersizer 2000. The pigment was black colored. Specific details on the composition of the pigment can be found in Table 1.

### Example 2

An amorphous zinc pigment was made by ball milling with a median particle size, d50, of 10.9 μm as measured by a Malvern Mastersizer 2000. The pigment was black colored. Specific details on the composition of the pigment can be found in Table 1.

### Example 3

An amorphous zinc pigment was made by ball milling with a median particle size, d50, of 12.5 μm as measured by a Malvern Mastersizer 2000. The pigment was black colored. Specific details on the composition of the pigment can be found in Table 1.

### Example 4

An amorphous zinc pigment was made by ball milling with a median particle size, d50, of 13.4 μm as measured by a Malvern Mastersizer 2000. The pigment was black colored. Specific details on the composition of the pigment can be found in Table 1.

### Example 5

An amorphous zinc pigment was made by ball milling with a median particle size, d50, of 9.6 μm as measured by a Malvern Mastersizer 2000. The pigment was black colored. Specific details on the composition of the pigment can be found in Table 1.

### Comparative Example 6

A Commercial Zinc Pigment

Table 1 describing the particles size, composition, and general properties of the zinc pigments from Examples 1-6.

| | Median | Unoxidized | Oxidized | Lubricant | | Oil |
|---|---|---|---|---|---|---|
| | particle size | Metal Content | Surface layer | Content | Salt Spray | Absorption |
| Sample ID | d50 (μm) | (%, w/w) | (%, w/w) | (%, w/w) | Test | gDPG/100 gZn |
| Ex. 1 | 11.7 | 76.4 | 23.2 | 0.39 | Pass | 16.3 |
| Ex. 2 | 10.9 | 72.2 | 27.4 | 0.38 | Pass | 17.2 |
| Ex. 3 | 12.5 | 76.7 | 22.9 | 0.40 | Pass | 17.9 |
| Ex. 4 | 13.4 | 78.0 | 21.3 | 0.71 | Pass | 18.3 |
| Ex. 5 | 9.6 | 75.4 | 24.3 | 0.35 | Pass | 19.3 |
| Ex. 6 (comp.) | 10.2 | 75.6 | 24.1 | 0.31 | Pass | 18.1 |

### Example 7— Waterborne Coating

25 g of the pigment of Examples 1-6 are dispersed into 57.4 g Uradil AZ800 (DSM) waterborne alkyd binder to create examples 7-1 to 7-6. The mixtures are reduced with 16 g water and 0.96 g of Nuodex Web Combi AQ (Rockwood Pigments UK).

Solvent-Borne Coating

Examples 1-6 were dispersed in a solvent-based automotive primer with the components shown in Table 2.

TABLE 2
Solvent-borne automotive primer recipe used
for salt spray analysis

| Ingredient | Loading (w/w) |
|---|---|
| Burnock EP 4011 | 42.07% |
| Zinc Pigment (Example 1-6) | 43.56% |
| Antiterra 204 | 0.70% |
| Tixogel MP 100 | 0.53% |
| Dicenate SG-160 | 0.64% |
| Exkin 2 | 0.27% |
| Byk A530 | 0.39% |
| Xylen | 4.48% |
| Solvesso 100 | 7.37% |

Oil Absorption Test:

Dipropylene glycol (DPG) is gradually added to 5 g of the Zn Pigment from Examples 1-6. At a certain point, the Zn pigment becomes wetted, forming a stiff paste with an oily surface sheen. The amount of DPG required to get to this point is reported as the g DPG/100 g pigment. The results are reported in Table 1.

Particle Size Measurement Test:

Approximately 0.7 g of the pigments from Examples 1-6 are dispersed into 45 mL isopropyl alcohol, then stirred on a magnetic stirrer for 5-10 min. The resulting slurry is added to A Hydro 2000 G dispersion unit that is attached to a Malvern Mastersizer 2000 and run according to the following protocol:

The setup for the sample is: Particle form: not spherical; refractive index: 0.8; absorption index: 3.1; density: 1.
The refractive index for the isopropyl alcohol is: 1.39 Calculated over volume density

Metal Content Measurement Test:

The content of unoxidized metal in the pigments was determined according to the protocol set forth in DIN EN ISO 3549, section 8. The results are reported in Table 1.

Lubricant Content Measurement Test:

14 g of the pigment from Examples 1-6 was added to an Erlenmeyer flask. 100 mL water was added to the flask, followed by 70 mL of concentrated HCl. The solution is heated until clear and transferred to a separatory funnel. The flask is rinsed with 200 mL t-butyl methyl ether and mixed for—5 minutes. The mixture is allowed to separate. The t-butyl methyl ether phase is discharged into a pre-weighed 500 mL Erlenmeyer flask equipped with 10 g sodium sulfate, and gently mixed for 4 hours. The ether phase is distilled, and the material remaining the round bottom flask is weighed to obtain the amount of fatty acid on the pigment. The results are reported in Table 1.

Salt Spray Test:

Salt spray resistance is assessed by adding pigment Examples 1-6 to a SB or WB coating and applying to a steel panel, then drying the coating, and mounting the panel in a salt spray chamber. Further details can be found by consulting ASTM B117; ISO 9227, JIS Z 2371 and ASTM G85. Failure is indicated to be the number of hours point at which significant rust and blistering is observed on the panel. Results are reported on a pass/fail basis as follows in Table 1:

Pass=when sampler, where x=1 to 5≥reference, where reference is example 6 and zinc dust VHZ 4p16
Pass=≥750 hr for red rust; also≥1000 hr.; and/or
Pass=≥150 hr for white rust; also≥225 hr.; and also≥250 hr.

Color Measurement Test:

3 g pigment are stirred into 5 ml paint by hand, where the paint contains 14.7 m % Plexigum MB 319 and 85.3 m % xylene.

Apply one drop of paint with 40 μm wet film thickness on paper and let it dry at room temperature for 24 hrs.
Measure L*15 with X-Rite MA98 with light source D65/10°

Gassing Test:

In a 250 mL Erlenmeyer flask, 6.6 g of pigment, 10 g of 2-butoxyethanol and 90 g of water was added with a magnetic stir bar. The flask was placed into an oil bath on a stir plate, stirred at 400 rpm and the oil bath heated to 40° C. Once the flask contents were warmed, a glass gassing apparatus was connected to the flask. The glass gassing apparatus allows for gas flow from the flask into a water containing chamber. As hydrogen gas is generated, the water chamber becomes pressurized and displaces water from the chamber into a graduated reservoir. The amount of water displaced was monitored over time—more water displacement indicated more gas generation. The test was run over an 8 hr period, where the amount water displaced was recorded at each hour. Failure is reached when 100 mL of water has been displaced.

Corrosion Test:

The coating of Examples 7-1 through 7-6 are spray applied to a degreased steel panel that has been coated on the reverse side at a thickness of 0.5 mil. The coating is allowed to cure for two days and vertically scored (with a razor or other cutting tool) from the center of the panel to the edge. The scored panel is immersed into a solution of the composition in Table 4 for 2 days and the corrosion is visually assessed on a 1-5 scale, with 1 meaning virtually no corrosion and 5 meaning highly corroded. The rating and description of the panels are reported in Table 3.

TABLE 3
Results of corrosion and gassing tests for
Examples 7-1 through 7-6

| | Gassing Test | | |
|---|---|---|---|
| | hours to fail or amount | | |
| | of water displaced in | | Corrosion Test |
| Sample ID | 8 hrs | | Result (1-5) |
| Example 7-1 | 68 | mL | 1 |
| Example 7-2 | 83 | mL | 2 |
| Example 7-3 | 25 | mL | 3 |
| Example 7-4 | 70 | mL | 5 |
| Example 7-5 | 55 | mL | 4 |
| Comp. Example 7-6 | 2 | hrs to failure | 2 |

TABLE 4
Bath composition used in the Corrosion Test

| Material | % (w/w) |
|---|---|
| DI Water | 95 |
| Glacial acetic acid | 2 |
| 30% Hydrogen peroxide | 1 |
| Sodium chloride | 2 |
| Total | 100 |

What is claimed is:

1. A zinc pigment suitable for use in a waterborne system, represented by equation 2:
1=ϕ_{M}+ϕ_{O}+ϕ_{L} (2)
where ϕ_{M}, ϕ_{O}, and ϕ_{L} are molar fractions of unoxidized zinc, an oxidized surface layer of zinc, and a lubricant, respectively;
and wherein the unoxidized zinc, ϕ_{M}, is in a range of 0.70≤ϕ_{M}≤0.90;
the oxidized surface layer of zinc, ϕ_{O}, is in a range of 0.10≤ϕ_{O}≤0.30;
the lubricant, ϕ_{L}, is in a range of 0.00≤ϕ_{L}≤0.50;
the zinc pigment has a particle size D50 in a range of 1 μm≤d50≤25 μm;
and wherein the zinc pigment has improved stability in waterborne systems.

2. The zinc pigment of claim 1, wherein the unoxidized zinc, ϕ_{M}, is in a range of 0.74≤ϕ_{M}≤0.86;
the oxidized surface layer, ϕ_{O}, is about 0.14 to 0.26;
the lubricant, ϕ_{L}, is in the range of 0.00≤ϕ_{L}≤0.05;
the zinc pigment has a particle size D50 in the range of 8.0 μm≤d50≤16 μm.

3. The zinc pigment of claim 1, wherein the oxidized surface layer is a water insoluble oxide or a hydroxide.

4. The zinc pigment of claim 3, wherein the oxide has the chemical formula (1)
ZnₐX_{b} (1);
wherein X represents either O or OH, and a and b are stoichiometric indicators of the amount of Zn or component X, and depends on the oxidation state of X.

5. The zinc pigment of claim 1, wherein the surface area is in the range of 0.5 m²/g-20 m²/g.

6. The zinc pigment of claim 1, wherein the surface area is in the range of 1 m²/g-5 m²/g.

7. The zinc pigment of claim 1, where the lubricant selected from the group consisting of saturated and unsaturated fatty acids and mixtures thereof.

8. The zinc pigment of claim 7, where the saturated fatty acid is a metal soap, and where metal of the metal soap is zinc.

9. The zinc pigment of claim 7, where the saturated fatty acid is a metal soap, and where metal of the metal soap is not zinc.

10. The zinc pigment of claim 8, wherein the metal soap is selected from the group consisting of zinc stearate, zinc oleate and mixtures thereof.

11. The zinc pigment of claim 7, wherein the saturated and unsaturated fatty acids have 1-30 carbon atoms.

12. The zinc pigment of claim 11, wherein the lubricant is selected from the group consisting of stearic acid, oleic acid, linoleic acid, ricinoleic acid, palmitic acid, arachidic acid, myristic acid, lauric acid, capric acid, elaidic acid, erucic acid, linolenic acid, myristoleic acid, palmitoleic acid and blends thereof.

13. A waterborne ink or coating system comprising the zinc pigment of claim 1.

14. The waterborne ink or coating system of claim 13, having a preferred brightness, L*, of <50.

15. A coated metal article comprising the zinc pigment of claim 1.

16. The coated metal article of claim 15, wherein the metal article is selected from the group consisting of metal panels, screws, fasteners, brakes, automatic chassis components.
